(19) United States
(12) Patent Application Publication
(10) Pub. No.: US 2025/0209434 A1
(43) Pub. Date: Jun. 26, 2025

(54) A CRYPTOGRAPHICALLY SECURE PROTECTION AND MANAGEMENT SYSTEM FOR ART DATA AND ART ASSETS

(71) Applicant: LDVS, Inc., San Marcos, CA (US)

(72) Inventors: Curtis G. McConnell, Carlsbad, CA (US); Daniel I. Bodenheimer, Del Mar, CA (US)

(21) Appl. No.: 18/850,390

(22) PCT Filed: Mar. 27, 2023
(86) PCT No.: PCT/US23/16456

§ 371 Date: Sep. 24, 2024

Related U.S. Application Data
(60) Provisional application No. 63/323,985, filed on Mar. 25, 2022.

(51) Int. Cl. G06Q 20/12; G06F 21/10; G06Q 20/38; G06Q 20/40; H04L 9/00

(52) U.S. Cl. CPC G06Q 20/1235; G06F 21/108; G06Q 20/382; G06Q 20/401; H04L 9/50

(57) ABSTRACT

Embodiments of the disclosed technology are directed to protecting and managing art data and art assets. The described embodiments bring trust to the entire art ecosystem by securely connecting physical (and digital) art to its verified provenance and due diligence data. An example method for authenticating an art asset includes receiving images and documents associated with the art asset, generating, based on the image and document, a non-interchangeable cryptographic asset associated with an authenticity of the art asset, generating, based on the non-interchangeable cryptographic asset, a smart contract for a transaction involving the art asset, and performing, based on the smart contract and the non-interchangeable cryptographic asset, the transaction.

### CROSS-REFERENCE TO RELATED APPLICATION

This application claims priority to and benefits from U.S. Provisional Patent Application No. 63/323,985, filed on Mar. 25, 2022, the disclosure of which is hereby incorporated by reference herein in its entirety.

### TECHNICAL FIELD

The present document is generally related to computerized systems for authenticating art data and art assets, and more specifically, to creating and configuring cryptographic assets for the management and authentication of art data and art assets.

### BACKGROUND

Art is the manifestation of human expression or creative skill and imagination, typically in a visual format such as painting or sculpture, an audio format such as music, or a mixture of both such as a performance, in which the produced artistic work is for appreciation and enjoyment for its attributes, beauty, message, meaning, significance, symbolism, and/or other aspects. Some of the oldest documented forms of art are visual arts that represent creation of images and objects. Visual artistic works include paintings, drawings and sketches, sculptures, printmaking, photography, and other visual media. Across the mediums of paintings, print and sculptures, and more increasingly, digital art, the provenance of an art asset is critical. Authenticating documentation, based on both qualitative and quantitative data, for an art asset provides the assurance the art asset is genuine and made by the artist or produced by its foundation.

### SUMMARY

Embodiments of the disclosed technology are directed to the protection and management of art data and art assets. The described embodiments bring trust to the entire art ecosystem by securely connecting physical (and digital) art to its verified provenance and due diligence data.

In an example aspect, a system for protecting an art asset includes a database resident on one or more computers, a processor in communication with the database, and a non-transitory memory including processor-executable code, wherein the processor-executable code upon execution by the processor causes the processor to authenticate data associated with an art asset and generate a set of cryptographic assets associated with the art asset. The processor receives at least one document and at least one image associated with the art asset, and generates, based on a digital representation of the at least one document and the at least one image, a platform cryptographic asset for the art asset. The platform cryptographic asset is used to generate a smart contract to perform at least one transaction involving the art asset, and the smart contract is executed to perform the at least one transaction. In this system, the set of cryptographic assets comprises (i) the platform cryptographic asset, (ii) a copyright cryptographic asset associated with a copyright of the art asset that includes royalty rights and reproduction rights, and (iii) a title cryptographic asset associated with ownership data of the art asset, and the set of cryptographic assets and the smart contract are stored on a distributed ledger.

In another example aspect, a method for protecting an art asset includes receiving, from at least a computing system associated with a seller of the art asset, images and documents associated with the art asset. The method further includes digitizing the images and documents, and converting a first format of digitized images and documents to a second format to generate a digital representation of the images and documents, the first format being incompatible with one or more data structures being used by a platform cryptographic asset. The method includes generating, based on a digital representation of the images and documents, the platform cryptographic asset associated with an authenticity of the art asset, authenticating the platform cryptographic asset using a proof-of-work consensus mechanism or a proof-of-stake consensus mechanism, and generating, based on the authenticating being successful, a title cryptographic asset associated an ownership of the art asset and a copyright cryptographic asset associated with a copyright of the art asset that includes royalty rights and reproduction rights. Having generated the cryptographic assets, the method includes generating, based on the platform cryptographic asset and the title cryptographic asset, a smart contract for a transaction involving the art asset between the seller and a buyer, verifying a transfer of funds from a buyer to a seller, and transferring the title cryptographic asset to a digital wallet associated with the buyer.

In yet another example aspect, the method may be embodied as processor-executable code and may be stored on a computer-readable program medium.

The subject matter described in this patent document can be implemented in specific ways that provide one or more of the following features.

### BRIEF DESCRIPTION OF THE DRAWINGS

Drawings described herein are used to provide a further understanding and constitute a part of this application. Example embodiments and illustrations thereof are used to explain the technology rather than limiting its scope.

FIGS. 1A and 1B show examples of a protection and management system according to embodiments of the presently disclosed technology.

FIGS. 2A and 2B are flowcharts showing an example registration and protection of an art asset according to embodiments of the presently disclosed technology.

FIG. 3 is a flowchart showing an example of an authenticated and verified sale of an art asset according to embodiments of the presently disclosed technology.

FIG. 4 is a flowchart showing an example of the creation of authenticated derivative works according to embodiments of the presently disclosed technology.

FIGS. 5A-5G show diagrams depicting a user interface of an example protection and management system according to embodiments of the presently disclosed technology.

FIGS. 6A and 6B are block diagram representations of portions of an apparatus that can be configured to implement some embodiments of the presently disclosed technology.

FIG. 7 shows a flowchart of an example method according to embodiments of the presently disclosed technology.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Furthermore, the terms blockchain and non-fungible token (NFT) are used for illustrative purpose only, and the disclosed techniques are applicable to any distributed ledger technology (DLT) and any non-interchangeable cryptographic asset or token, respectively.

Embodiments of the disclosed technology use a distributed ledger, e.g., blockchain or Hashgraph, to offer a transparent solution for the protection and management of art data and art assets. DLT provides an excellent way to protect against data manipulation and fraud in the art industry, and provides a complement to an internal change log, and using non-interchangeable cryptographic assets or tokens provide an un-hackable way to maintain provenance of all due diligence data. A cryptographic asset or token is a purely digital creation that uses DLT over a digital network, e.g., the Internet, to establish ownership and/or transactions.

### 1 Introduction and System Overview

Given the number of forgeries circulating in the market, authenticating art has become an essential business. Collectors investing in artwork from emerging and established artists face a significantly greater chance that the artwork they have purchased is fake. According to the Fine Art Expert Institute (FAEI), 50 percent of art circulating on the market is forged or misattributed. When purchasing artwork, especially ones that have significant value, a buyer or collector should take steps to verify that the work is authentic. Relying on the seller's word or personal knowledge may not be enough. After all, anybody can print a “Certificate of Authenticity,” but without the proper documentation to back it up, you might as well use it as starter paper in your fireplace.

In an example, embodiments of the disclosed technology provide a hash of all records changed per work of art per day to ensure that unauthorized sales or transfers cannot be effectuated. This is in addition to all transactional data that is fully logged like transfer of ownership, new identifiers, financial transactions (loans, liens, etc.). Furthermore, the described embodiments can be configured to provide both a full audit trail of all changes, activity, and data related to an art asset that is included in the system, as well as a robust alerting system to proactively send messages on significant entries of note. For example, provenance of an art asset includes one or more of the following that can be incorporated into any distributed ledger to establish a level of trust associated with the art asset that can travel with the art asset from that point forward:
a signed certificate or statement of authenticity from a respected authority or expert on the artist,
an original gallery sales receipt or receipt directly from the artist,
an appraisal from a recognized authority or expert on the artist,
names of previous owners of the art,
newspaper or magazine articles mentioning or illustrating the art,
a mention or illustration of the art in a book or exhibit catalog, and/or
verbal information is related to someone familiar with the art or who knows the artist and who is qualified to speak authoritatively about the art.

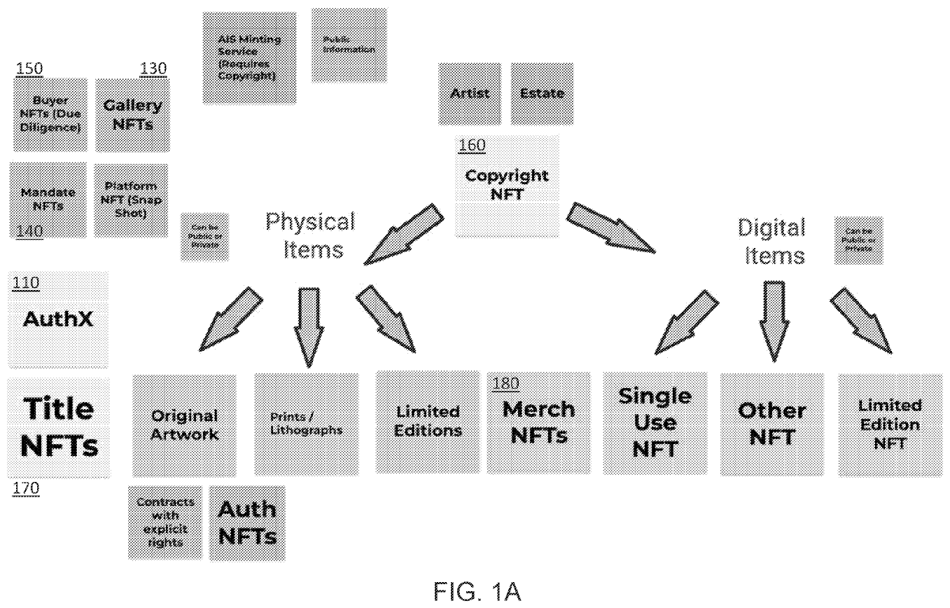

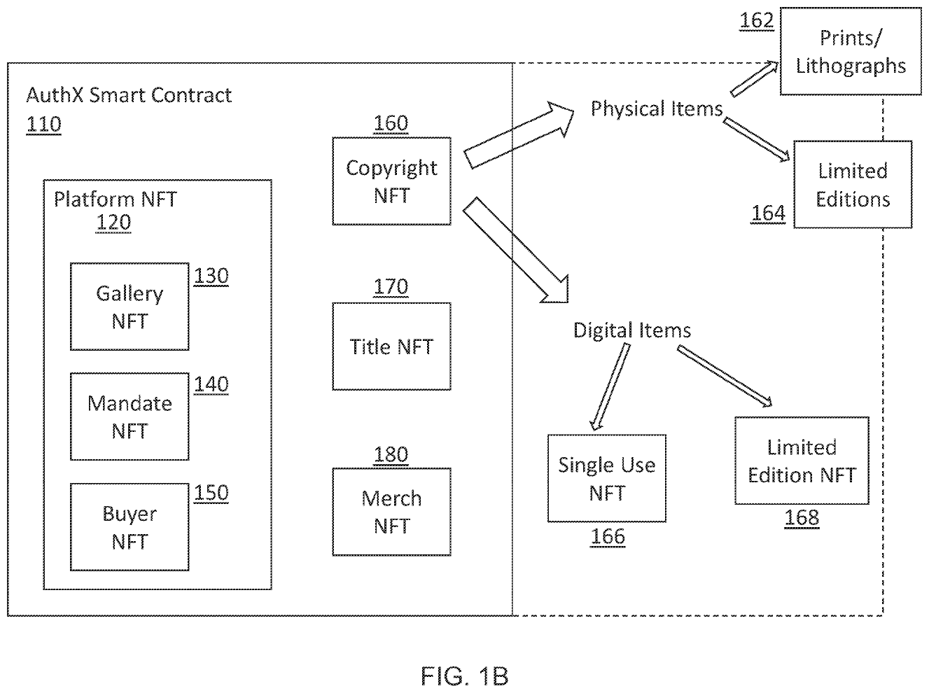

FIGS. 1A and 1B show example embodiments of a protection and management system according to embodiments of the presently disclosed technology, and shows the interactions between the various non-interchangeable cryptographic assets (shown as NFTs in FIGS. 1A and 1B) associated with an art asset. The described embodiments are configured to be used with physical items (e.g., paintings, sculptures, etc.) as well as digital items (e.g., images, video recordings, and audio recordings in various formats), and support a plethora of use cases including creating derivative works (including limited editions), exercising contractual rights, and enforcing copyright.

The described embodiments include methods and systems for creating and managing non-interchangeable cryptographic assets (e.g., NFTs) that represent physical items and enable their transactions as digital assets. An example system includes a virtual wrapper (e.g., Platform NFT described in Section 2.1) that generates an NFT for a physical item based on its metadata, such as its description, image, location, ownership history, etc. The virtual wrapper also connects secure unique identifiers to the physical item, e.g., a Radio Frequency Identification (RFID) tag (e.g., using either a Near-Field Communications (NFC) chip or an Ultra-High Frequency (UHF) chip) or a digital fingerprint, etc., that links it to the corresponding cryptographic asset. The system further comprises (a) an authentication component that verifies the authenticity of the physical item and its cryptographic asset by reading the identifier and comparing its encrypted data with the metadata stored on any distributed ledger technology, and (b) a smart contract (e.g., AuthX smart contract described in Section 2.4), which handles various aspects of the transaction process, such as standard and bespoke contracts, escrow services, physical movement and shipping, storage arrangements, authentication procedures, royalty payments, fee settlements, etc.

Embodiments of the disclosed technology simplify and secure the transactions of physical items as digital assets by leveraging the benefits of non-interchangeable cryptographic assets, such as uniqueness, verifiability, traceability, programmability, etc.

### 1.1 Overview of Cryptographic Assets and Smart Contracts

A non-interchangeable cryptographic asset (e.g., an NFT) is a unit of data stored as a hash on a given digital ledger that enables a digital asset to be unique and not interchangeable and/or enables access rights to an associated object (such as digital content or a physical artwork) or metadata. NFTs can be implemented on blockchains which support smart contract programming. The NFT can be any token (being transferrable tokenized data in the form of a hash corresponding to a transaction) that represents a unique value and is not readily substitutable in value for another token. The purpose of the token is to record information related to access of and characteristics of the asset.

The unique properties of an NFT, notably by whom (or by which digital wallet) it is owned and any external links or pointers, are generally stored in each token's metadata; that is, a set of data that describes and gives information about other data. Many protocols that host NFTs have a metadata extension that allows smart contracts to be interrogated not only for their name but also for particulars about the assets the NFTs represent.

Creating (or “minting”) NFTs is the process of uniquely publishing your token on a blockchain to make it publicly accessible (including making it purchasable). Minting an NFT typically involves creating digital data corresponding to an asset (e.g., creating a Platform NFT by digitizing all physical documentation associated with an artwork), buying cryptocurrency for the distributed ledger technology to be used (e.g., ETH for Ethereum, BTC for Bitcoin), using the cryptocurrency to add the digital data to an NFT collection in an NFT marketplace, and creating a corresponding token corresponding to that digital data.

In the example described herein, funds that can be exchanged (i) can include conventional fiat currency and/or cryptocurrency and (ii) through a digital wallet, which can include an electronic device, online service, or software program that allows a party to make an electronic transaction with another party bartering currency units for goods and services.

Tokens are created by verifying the digital data and adding them to a distributed ledger, and rely on consensus mechanisms to ensure the legitimacy of the distributed ledger transaction. The two most common consensus mechanisms used by cryptocurrencies are “proof-of-work” and “proof-of-stake.” Proof-of-work blockchains are secured and verified by virtual miners around the world racing to be the first to solve a math puzzle. The winner gets to update the blockchain with the latest verified transactions and is rewarded by the network with a predetermined amount of cryptocurrency. Proof-of-work is a proven, robust way of maintaining a secure decentralized blockchain.

Different from proof-of-work blockchains in a proof-of-stake blockchain, a network of “validators” are employed who contribute—or “stake”—their own crypto in exchange for a chance of getting to validate new transaction, update the blockchain, and earn a reward. The network selects a winner based on the amount of crypto each validator has in the pool and the length of time they have had it there—literally rewarding the most invested participants. Once the winner has validated the latest block of transactions, other validators can attest that the block is accurate. When a threshold number of attestations have been made, the network updates the blockchain, and all participating validators receive a reward in the native cryptocurrency.

Energy consumption is one major difference between the two consensus mechanisms. Because proof-of-stake blockchains do not require miners to spend electricity on duplicative processes (competing to solve the same puzzle), proof of stake allows networks to operate with substantially lower resource consumption. Both consensus mechanisms have economic consequences that penalize network disruptions and thwart malicious actors. In proof of work, the penalty for miners submitting invalid information, or blocks, is the sunk cost of computing power, energy, and time. In proof of stake, the validators' staked crypto funds serve as an economic incentive to act in the network's best interests. In the case that a validator accepts a bad block, a portion of their staked funds will be “slashed” as a penalty. The amount that a validator can be slashed depends on the network.

A smart contract is a program, which can be stored on a blockchain, that executes an agreement between parties to legal contract when predetermined conditions associated with the program and/or legal contract are met. A smart contract can automate the agreement in a manner that removes uncertain outcomes for the parties, e.g., automating workflow(s), triggering next action(s), etc., such as initiating the release of funds, sending a notification, creating and/or submitting a form, or other action of the smart contract.

In some embodiments, a cryptographic asset is non-transferable when it cannot be transferred by the recipient after it has been received. For example, the recipient cannot transfer the cryptographic asset to another person/entity, another digital wallet, or another distributed ledger. In other embodiments, a non-transferable cryptographic asset cannot be transferred from one person/entity to another, but is not restricted from being transferred, for example, from one digital wallet to another digital wallet belonging to the same person/entity, or from one distributed ledger to another distributed ledger being used by the same person/entity (e.g., to enable the recipient to pay in either Ether or Bitcoin). A transferable cryptographic asset can be transferred between persons/entities, digital wallets, and/or distributed ledgers.

### 2 Components of an Example Embodiment

Various non-interchangeable cryptographic assets used to implement the described embodiments are discussed below. FIGS. 1A and 1B show different aspects of a protection and management system according to embodiments of the presently disclosed technology.

### 2.1 Platform NFT

Platform NFTs (or more generally, Platform non-interchangeable cryptographic assets) are non-transferable NFTs that are specific for works of art at a specific point in time. A Platform NFT is a snapshot of all available data related to a specific artwork (or art asset). In an example, it includes all documents and data that are meant to be shared with prospective buyers, service providers, and experts. A Platform NFT is non-transferable by default, but can be made non-revocable in the case that the associated artwork is sold by the owner. A duplicate Platform NFT can be created and preserved as part of the record of sale that stays with the art asset, but the original remains with the previous owner in case of future litigation or dispute resolution.

In some embodiments, the Platform NFT 120 provides access to the cryptographically secure protection and management system, as described in this document. In an example, detail data logs, which would not typically be part of the Platform NFT in order to minimize storage and data transmission requirements, will be available on the cryptographically secure protection and management system, and can be accessed at any time with the Platform NFT. In certain use cases, access to data is limited to documents. In other use cases, access to data may include financial data and other audio/visual data related to the art asset.

In some embodiments, the cryptographically secure protection and management system includes a platform module configured to create the Platform NFT at a specific point in time such that it includes all available data (e.g., logs, history, due diligence, stories, transactions, reports, exhibitions, provenance, authenticity analysis, etc.) related to a specific artwork (or art asset) at that specific point in time. The Platform NFT advantageously facilitates transparency and trust in art transactions. Upon discovery or creation of new information or documentation, a new Platform NFT can be generated to incorporate the new information or documentation. In this sense, the Platform NFT is an immutable non-interchangeable cryptographic asset allowing a buyer, seller, or agent to verify the authenticity of an art asset at a particular point in time.

In some embodiments, the Platform NFTs include a Gallery NFT 130, which includes private images and data for a work of art that can be shown in a digital wallet, and replaces the conventional way that owners of art can share the collection (websites, photo gallery in their phones, Instagram, etc.). The Gallery NFT is an official object/token label/passport that can be used to establish control or ownership (e.g., including permitted or legal use) of an artwork (or more generally, an art asset) that can be displayed in a crypto-wallet and used to securely share images and other public data.

In some embodiments, the Platform NFTs include a Mandate NFT 140, which can only be issued by the owner to prospective dealers, seller agents, galleries and auction houses for consignment purposes. The Mandate NFT is non-transferable (by the recipient) and can be revoked by the owner of record manually or according to the terms of the contract. This framework is designed to advantageously eliminate agents (brokers, dealers, or individuals) from misrepresenting their relationship to the art and owners, while also making it much easier for representatives of buyers and sellers to establish trust, especially when many participants wish to remain anonymous.

In some embodiments, the Platform NFTs include a Buyer or Due Diligence NFT 150, which can be issued to an approved or qualified buyer as the first step of due diligence. Because this is a non-transferable NFT, the buyer is granted limited access to data including images through this NFT and by extension to the platform and maintains this information only as long as the seller is inclined to share it.

In some embodiments, the Platform NFTs include a Passport NFT (not shown in FIG. 1B), which can be used to track bills of lading, custom clearances, and/or information related to the nearest freeport that can be used to store the artwork. In some implementations, the functionality of the Passport NFT may be incorporated into the Gallery NFT, which is used to exhibit the collection, and will therefore rely on information regarding the transportation and storage of the artwork.

In some embodiments, the Platform NFT is created with one or more of the Gallery NFT, Mandate NFT, and/or Buyer or Due Diligence NFT, which requires the assimilation of information from a variety of sources. For example, some certifications of authenticity may come from artists, artists' descendants (“droit moral”), and institutions that specialize in the works of that artist (e.g., The Andy Warhol Art Authentication Board, Inc. that certified the authenticity of works by Andy Warhol), whereas certain purchase and sale records may come from an art gallery or art broker/agent. Each of these institutions and/or persons likely use different software to maintain their records, and thus embodiments of the disclosed technology are configured to standardize the data received into a format that is used by the Platform NFT. In an example, the format standardization mechanism implemented by the disclosed technology is based on the software that is used by the provider of the information and/or records. In another example, the audio/visual information associated with an art asset may not be compatible with encapsulation within a cryptographic asset (e.g., the incoming file format might be too large to store within an NFT), and the disclosed technology converts the audio-visual information into a format that is compatible with the Platform NFT.

### 2.2 Copyright NFT

When an artist “manufacturers” a piece of artwork, the copyright remains with the artist unless explicitly stated. All royalty payments go to the copyright holder. The Copyright NFT 160 allows clear transfer of the copyright ownership, along with royalty rights and reproduction rights. The Copyright NFT is transferable by default. The Copyright NFT also contains the permissions to mint Merch NFTs (described in Section 2.5) and other merchandise that use the likeness of the original art, such as, but not limited to, lithographs, posters, mugs, t-shirts, other physical and digital items.

### 2.3 Title NFT

Title NFTs are the “digital twins” of art works. A Title NFT 170 is used for enforcement of royalties, licensing and fractional/share ownership rules. Transfer of title will have associated fees, but unlike AuthX smart contracts (described below), percentage of sales like royalties will be subject to self-reporting including declaration of sales amount. Transfer will be contingent on removal of liens, loans and other encumbrances where they apply. When encumbrances are applied, the Title NFT will likely be moved to a custodial account to limit transfers without resolution of legal responsibilities. In an example, the disclosed technology can be leveraged to interface with law enforcement, banks, and the current possessor of the artwork in order to add an encumbrance.

In some embodiments, and as part of typical art sales these new Title NFTs can be transferred to the new owner's wallet upon sale (transfer of money) even prior to taking physical possession of an artwork. Alternatively, the Title NFT can also be given to an individual custodian's wallet (lawyer, law firm, logistics company) or custodial wallet (escrow company, bank, government agency) in a number of cases, e.g., joint familial ownership, JV, corporate collection, public (securitized art), in the case of a loan against the art, mechanics lien, escrow pending final sale, and in the case of disputed ownership (civil or criminal). The Title NFT is transferable by default.

Title NFTs will pave the way for title insurance and be a requirement for Art Loss Registry and similar type certification. Any work of art on the described platform will be publicly searchable for this type of NFT (the owner may remain private, but the existence of the Title NFT will be public).

### 2.4 AuthX Smart Contract

The AuthX smart contract 110 is a means for tokenizing, certifying, and securitizing art works on the described platform, which enables the artwork to be transacted. It contains all the terms and conditions of the sale, as well as the due diligence data that verifies the quality, provenance, and ownership of the artwork (e.g., the AuthX smart contract can include the Platform NFT). In some implementations, the due diligence data is stored in child NFTs that are linked to the AuthX smart contract. An AuthX smart contract can facilitate secure and legally compliant transactions of art by enforcing contract terms, encumbrances, royalties, or copyright.

The AuthX smart contract is a self-executing contract and includes all of the terms and conditions of the sale of an artwork (digital and physical). The AuthX smart contract will only be created when specific due diligence standards are met including scoring of the art data, certification of clean title, KYC (know your customer)/AML (anti-money laundering) for owner (e.g., to comply with governmental and industry regulations). Not all AuthX smart contracts will meet the standards of a publicly tradable asset, however all publicly traded artworks will likely have at least one associated AuthX smart contract. What makes the AuthX smart contract more robust is that each AuthX smart contract can have children NFTs that encapsulate and notarize each independent piece of due diligence attached to the corresponding AuthX smart contract.

In some embodiments, the AuthX smart contract facilitates the KYC/AML, due diligence, escrow, physical inspections, transfer of title and all supporting dossier records, which support one or more of the following:
Anonymous buyer and seller, yet still KYC/AML compliant
Proof of funds
Proof of ownership/proof of seller mandate
Secure due diligence based on non-transferable documents with digital watermarking and traceability
Multiple step executions of a transaction with automatic rollback
Title transfer
Automatic commission and/or royalty payments
Instantaneous release of funds
Manual inspection and identification steps
Release and payment of encumbrances
Registration of works for law enforcement in case of theft or damage
Standard contractual terms for dispute resolution.
Automatic transfer of ownership of records and control to new owner

In some embodiments, the AuthX smart contract is configured to determine the type of blockchain and/or hardware (e.g., the device being used to transact could be a secure terminal in an auction house, a smartphone, a personal computer) that is being used in the transaction. Because the hardware being used may have different capabilities, e.g., the secure terminal in the auction house likely can access to significantly more processing power than the smartphone, the AuthX smart contract can appropriately select either a proof-of-work or a proof-of-stake consensus mechanism when performing the necessary verification and validation steps in order to finalize the transaction.

In some embodiments, and as shown in FIG. 1B, the AuthX smart contract (either the existing AuthX smart contract or a new AuthX smart contract) is configured for transactions involving derivative works of the original art asset. After validating the Copyright NFT 160, derivative works may be created. For a physical artwork, the derivative works may include prints/lithographs 162 and limited editions 164, whereas for a digital artwork, the derivative works may include a single-use NFT 166 and a limited edition NFT 168.

### 2.5 Merch NFT

A Merch NFT 180 is akin to a child reproduction with a digital experience, which is similar to the gaming NFT space. These are collectible reproductions (modern lithographs or digital prints) which may have high value based on rarity and connection with the artist, estate or owner (museums are a primary customer). In order to mint a Merch NFT, one must hold the Copyright NFT or have a Mandate NFT to create sellable and transferable digital (or physical) assets.

### 3 Example Use Cases of the Disclosed Technology

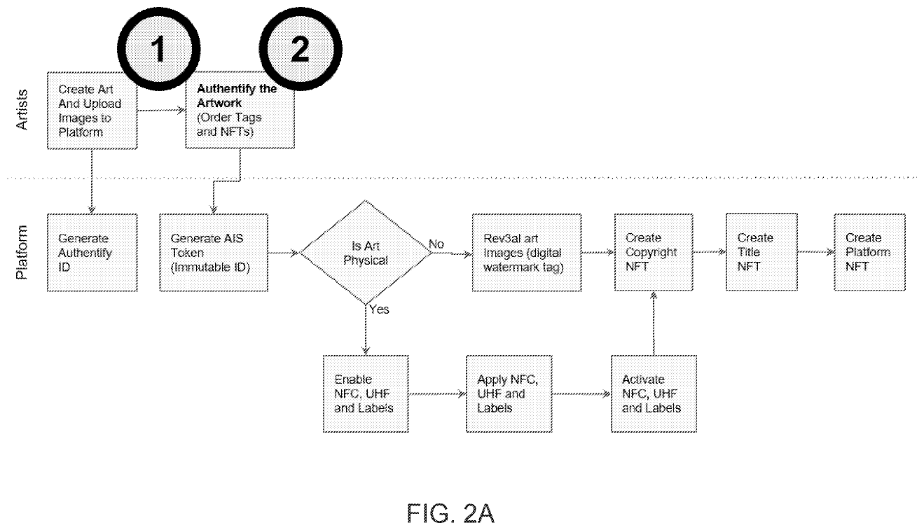

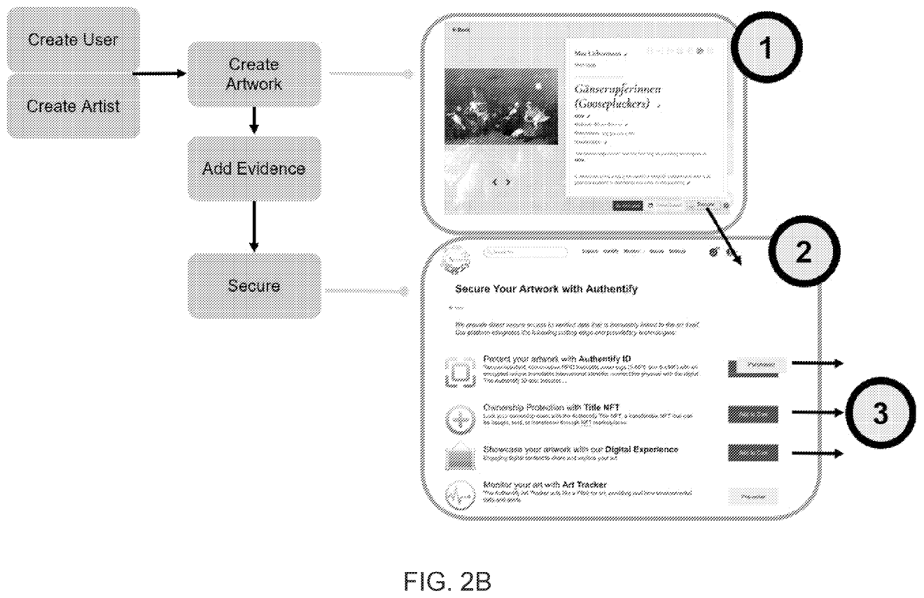

FIGS. 2A and 2B are flowcharts showing an example registration and protection of an art asset according to embodiments of the presently disclosed technology.

As shown in FIG. 2A, an artist can create an artwork and upload images associated with the artwork to the platform [Step 1] with a request for that particular artwork to be authenticated, which includes ordering tags (for a physical work of art) and creating NFTs [Step 2]. The platform is configured to generate a platform identifier and a cryptographic identifier (e.g., an AIS token) for the artwork. If the artwork is a physical piece of art, an identification tag (e.g., a secure NFC or UHF RFID tag) is enabled, affixed to the artwork, and then activated. If the artwork is a purely digital piece of art, a digital watermark may be added to the artwork. The platform now generates multiple cryptographic assets associated with the artwork, which enable its authentication, tracking, etc. throughout its existence. These multiple cryptographic assets include a platform NFT, copyright NFT, and a title NFT, as described earlier in this document.

FIG. 2B shows another example of registration and protection of an art asset according to embodiments of the presently disclosed technology. This example includes some features and/or steps that are similar to those shown in FIG. 2A, and described above. At least some of these features and/or steps may not be separately described in this section. As shown in FIG. 2B, a user/artist can create an account on the platform, which enables the artist/user to add evidence related to the creation of the artwork [Step 1], and then secure the artwork using the described embodiments [Steps 2 and 3].

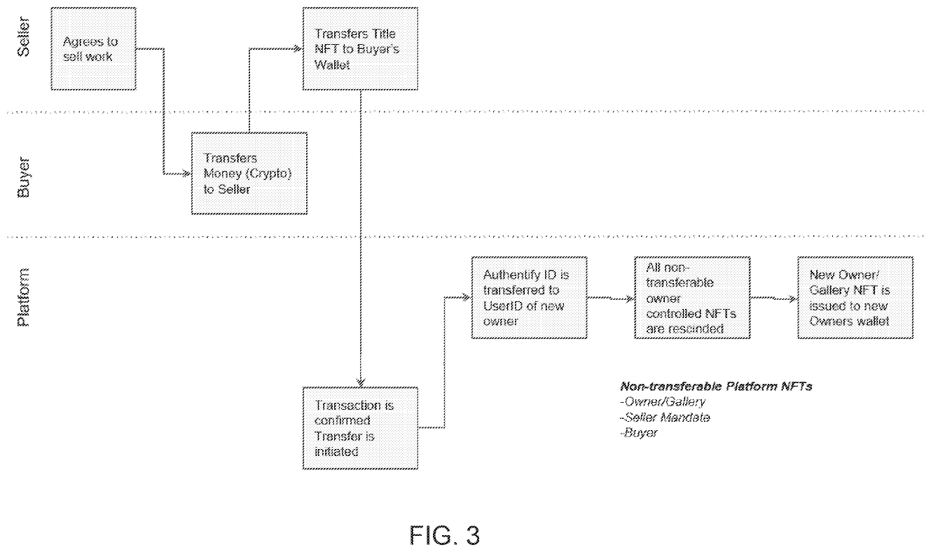

FIG. 3 is a flowchart showing an example of an authenticated and verified sale of an art asset according to embodiments of the presently disclosed technology. This example includes some features and/or steps that are similar to those shown in FIG. 2A, and described above. At least some of these features and/or steps may not be separately described in this section. As shown in FIG. 3, once a seller agrees to sell the artwork, a buyer can transfer the purchase amount (e.g., in cryptocurrency) to the seller, after which the seller transfers the title NFT to the buyer's wallet. Once the title NFT is transferred to the buyer's wallet, the platform confirms the transaction, and initiates the transfer of the artwork from the seller to the buyer.

Embodiments of the disclosed technology leverage the described NFTs to ensure that the transfer of the artwork from a seller to a buyer is verified, protected, and authenticated. This advantageously mitigates false claims and many instances of fraud (e.g., a seller attempting to sell an artwork that they are not authorized to sell).

Continuing with the description of FIG. 3, the platform transfers both the platform identifier and the cryptographic identifier to the buyer, and all non-transferable NFTs that were associated (or owned) by the seller (e.g., the Platform NFTs) are now rescinded. New Platform NFTs are created and deposited into the buyer's wallet, thereby completing the transaction. In an example, rescinding the Platform NFT results in the Platform NFT becoming an artifact because it does not include information related to the new buyer, and may typically only be used for future litigation.

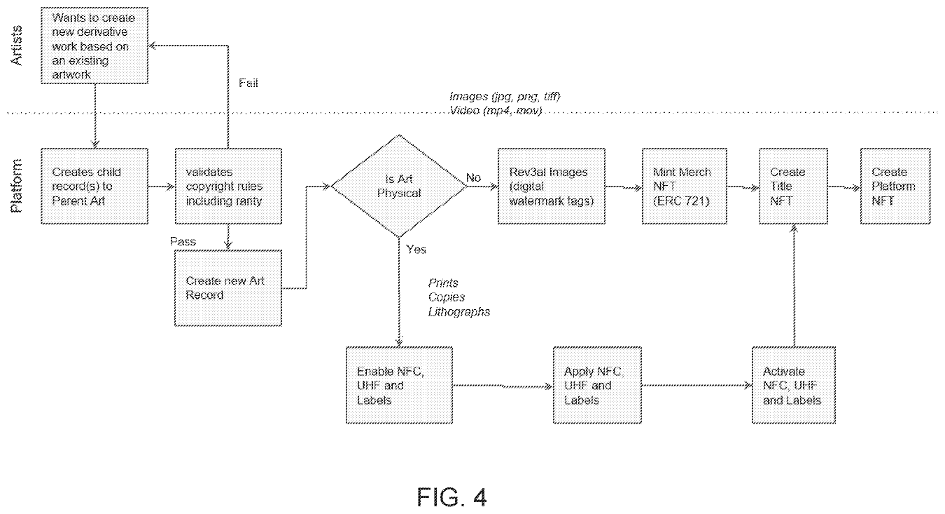

FIG. 4 is a flowchart showing an example of the creation of authenticated derivative works according to embodiments of the presently disclosed technology. This example includes some features and/or steps that are similar to those shown in FIGS. 2A and 3, and described above. At least some of these features and/or steps may not be separately described in this section. As shown in FIG. 4, an artist (or legitimate owner of the copyright) may want to create a derivative work based on the original artwork. In this case, the platform creates a child record that establishes that the artwork that is to be created is a derivative work of the original artwork. Once the child record is created, the copyright rules are verified and the Copyright NFT is validated. Only if a derivative work is authorized, will the creation of the new artwork begin. In some embodiments, a Merch NFT is created for the derivative work.

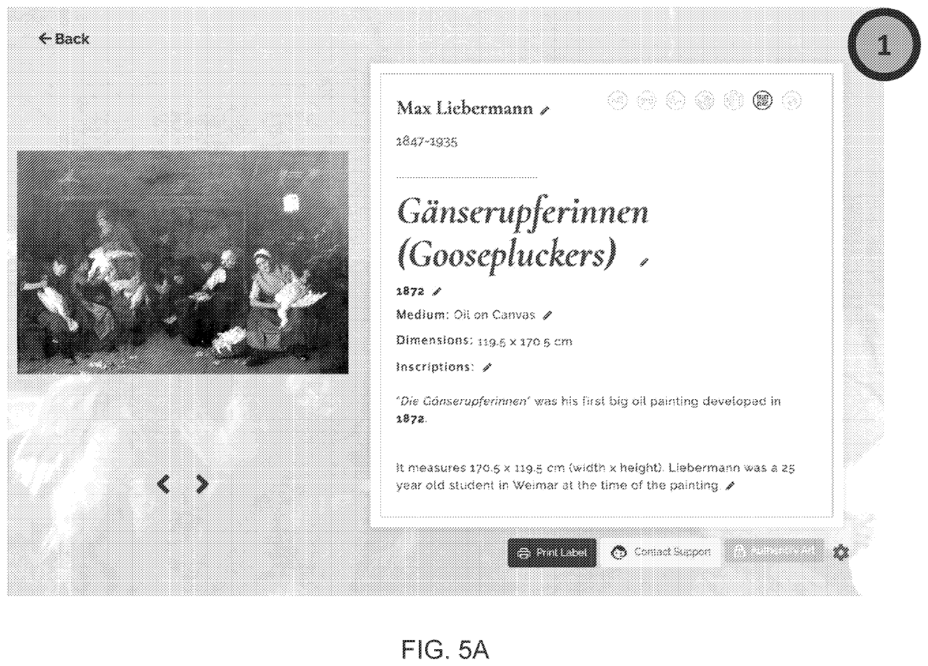

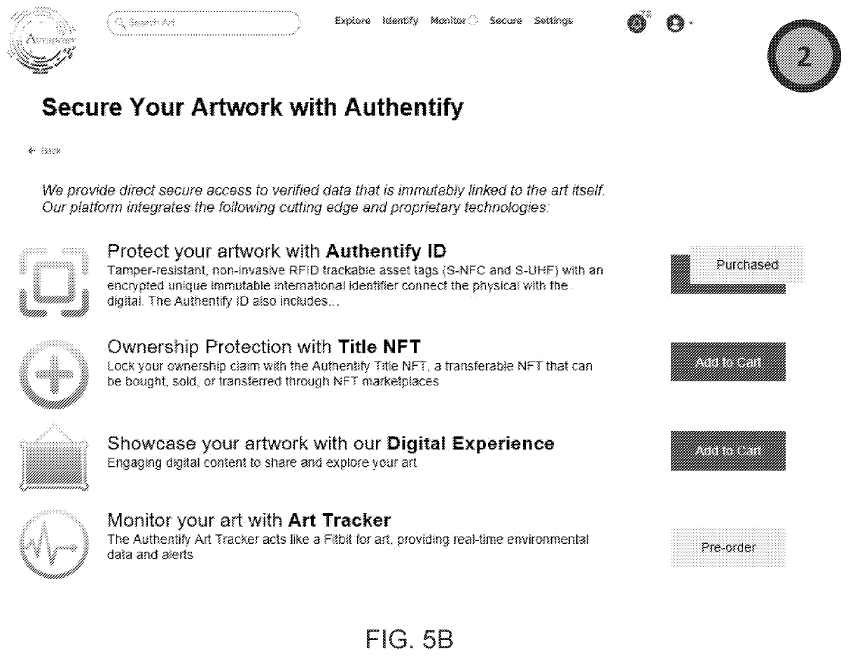

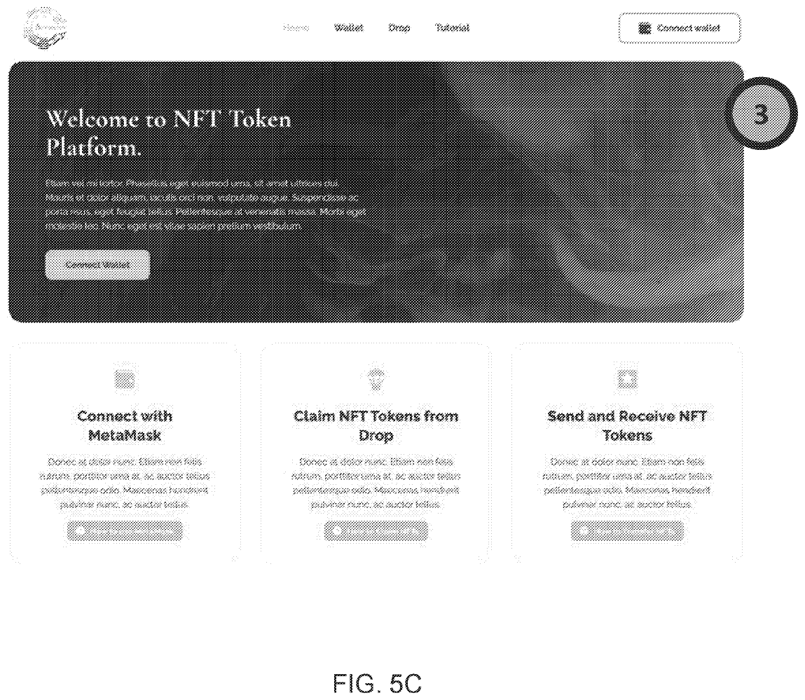

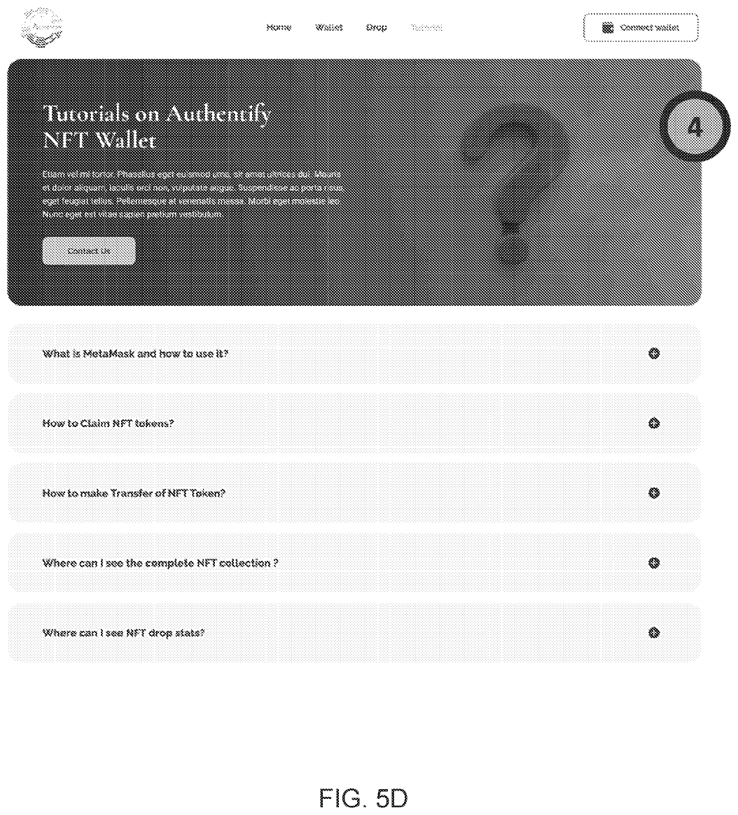

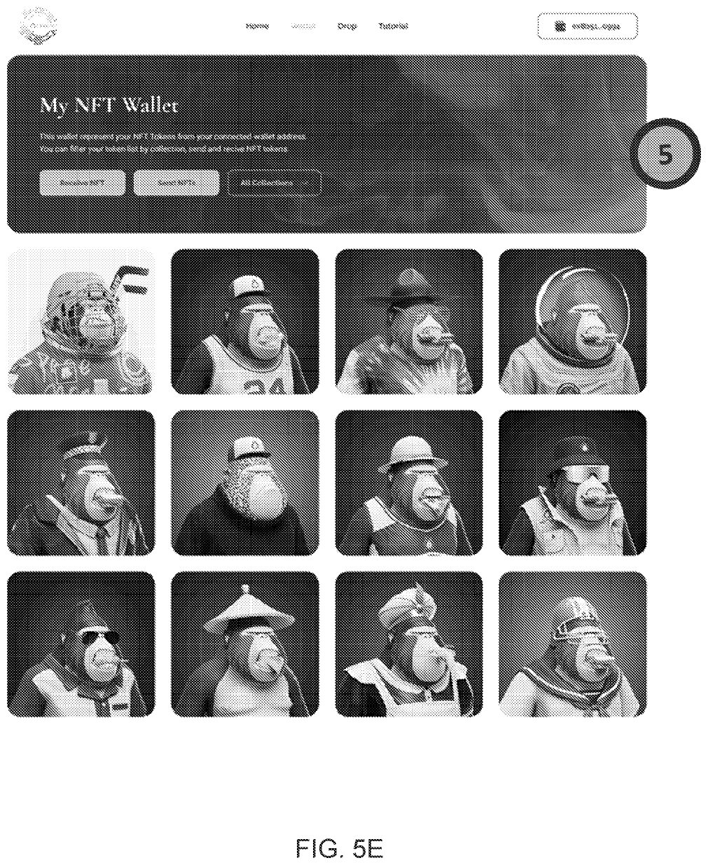

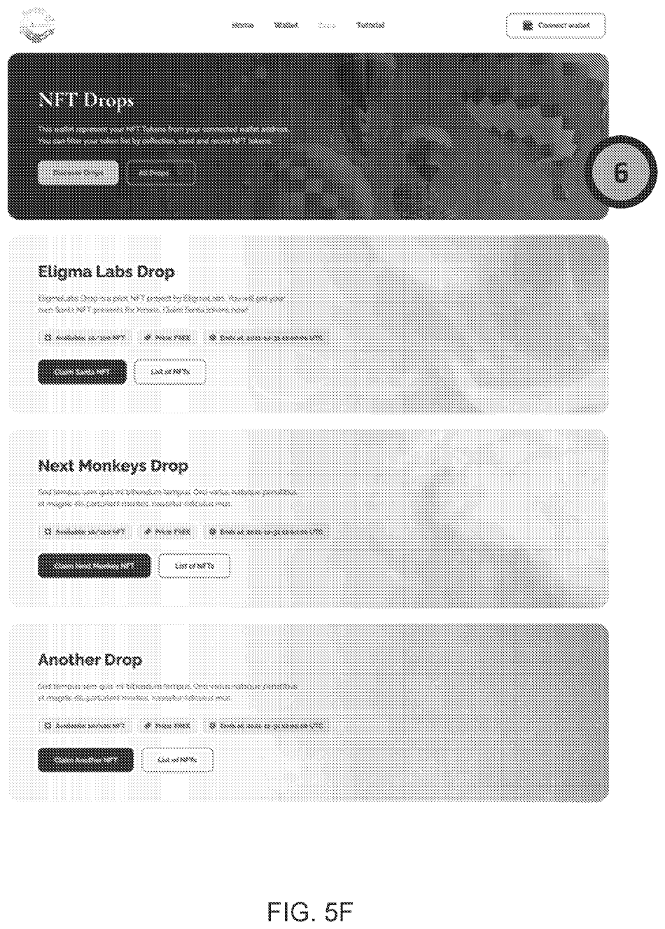

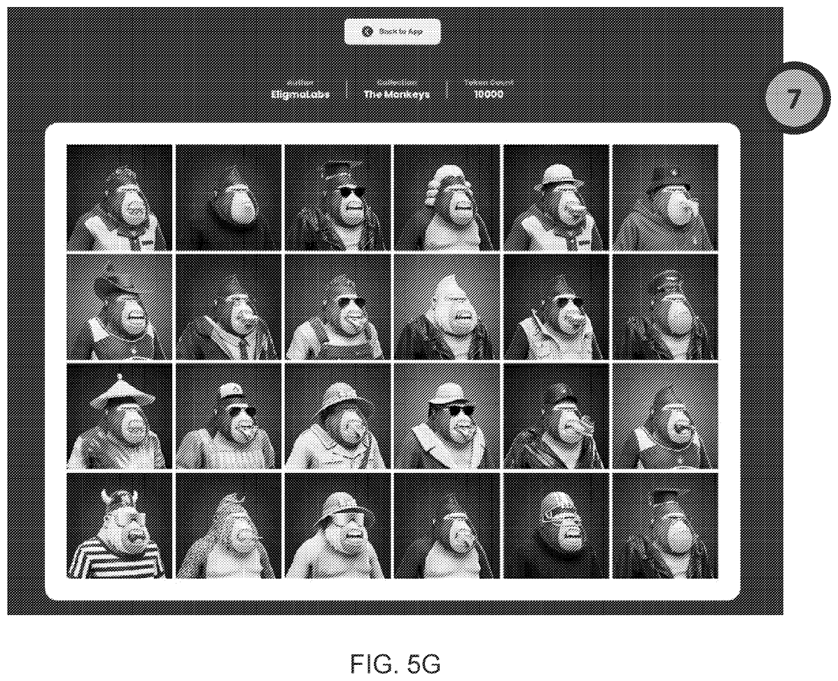

FIGS. 5A-5G show illustrations depicting a user interface of an example protection and management system according to embodiments of the presently disclosed technology. FIG. 5A shows a screenshot from the example user interface showing of information related to an artwork; FIG. 5B shows a screenshot from the example user interface that begins the process of protecting the artwork using the described embodiments, and FIG. 5C shows a screenshot from the example user interface depicting an example landing page. In an example, this landing page can be used to onboard users, but allowing them to connect to their digital wallet (e.g., Metamask, Coinbase, Zengo) and buy/sell NFT tokens. FIG. 5D shows a screenshot from the example user interface showing a tutorial or FAQ page that provides information related to various aspects of both protecting artwork, as well as using specific cryptocurrencies and platforms that are compatible with the described embodiments. FIG. 5E shows an example of the NFTs in a wallet, FIG. 5F shows an example of the various marketplaces that can be accessed to purchase (or sell) NFTs, and FIG. 5G shows an example of a specific marketplace. In some embodiments, the platform can be configured to use a set of API that enable the blockchain system and associated smart contracts to interface with any existing cryptocurrency platform, e.g., Bitcoin, Ethereum, Polygon, etc.

In an example, embodiments of the disclosed technology can be used when an artist is selling an artwork through a dealer to an anonymous art collector. Herein, the artist creates a physical artwork and registers it through the creation of a Platform NFT and a corresponding AuthX smart contract using the described embodiments. The AuthX smart contract includes metadata of the artwork notarized by the artist including its dimensions, materials, images, videos, and legal documents such as copyright and title. In this case, because a physical artwork is being transacted, the AuthX smart contract also includes identifiers such as a secure NFC RFID tag, a UHF RFID tag, or a digital fingerprint.

In some situations, the artist may specify the royalty percentage that they will receive from future sales of the artwork. Then, the artist consigns the artwork and its digital assets to an agent (such as a galley, dealer, auction house) that agrees to promote and sell the artwork on the artist's behalf. As part of the consignment, the artist and agent agree to commission fee that that it will receive from the sale of the artwork.

When a prospective buyer decides to purchase the artwork (at a negotiated price, list price, or hammer price) a transaction using the AuthX smart contract is initiated, which includes all the necessary steps required to complete the transaction. For example, the AuthX smart contract validates the transaction steps (including, but not limited to, KYC/AML, proof of funds, inspections of art, appraisal, relief of liens, shipment and receipt of artwork) which ultimately transfers ownership and custody of the artwork from the seller (in this case the artist) to the art collector. Simultaneously, the AuthX smart contract distributes payments to all parties involved in accordance with their specified agreements (lien holders, agents, seller, artist, gallery owners, government entities, etc.).

In another example, embodiments of the disclosed technology can be used when an owner of an artwork has alleged, in a lawsuit, that he was sold a forgery. When the owner bought the artwork through the described protection and management system, a Platform NFT was minted containing all data about the artwork, such as its description, image, provenance, authenticity analysis, etc. The owner verified the data and trusted the veracity and completeness of the Platform NFT as a reliable source of information prior to the purchase.

When the owner discovers that the artwork is inauthentic (a copy or fake), he believes that the seller deceived him, and files the lawsuit alleging fraud and breach of contract. The owner claims that he is entitled to all his money plus compensation for the damages caused by the seller's misrepresentation. The seller defends himself by arguing that he had sold the artwork a in good faith and that he had no knowledge or intention of selling a forgery, and that he too had relied on the data provided by a previous Platform NFT as well, and that he was not responsible for any errors or omissions in it. Here, the previous Platform NFT was updated to incorporate new information the seller had and resulting in the minting of the Platform NFT as part of the creation of the AuthX smart contract for this transaction.

The court examines the evidence presented by both parties, including the artwork and its two Platform NFTs. The court uses a verification module of the described system to validate the accuracy and reliability of the data stored in the Platform NFT at the time of the transaction. The court also used the presentation module of the described system to access different views and layers of information about the artwork and its Platform NFT depending on their relevance and importance to the case. The court finds that the Platform NFT is indeed comprehensive, and that it reflected all the information known about the artwork at the time of the transaction. The court also finds that the data in the Platform NFT was verified using various techniques, such as blockchain or other distributed ledger technology, digital signatures, encryption, hashing, etc., and that it could not be tampered with or altered without leaving traces. Therefore, the court concludes that the Platform NFT was a trustworthy representation of the artwork as a digital asset. Based on this evidence, the court rules in favor of the seller and dismisses the owner's claims. The court holds that there was no fraud or breach of contract on part of the seller because he had disclosed all information available to him through Platform NFT at time of transaction. The court also holds that the owner assumed the risk of buying an item based on its Platform NFT without conducting further due diligence or independent verification.

In yet another example, embodiments of the disclosed technology can be used when an artist sells an artwork, but allowed to retain access to the Platform NFT from the time it was sold. Here, as part of a sale of an artwork by an artist, he/she can be granted permission to access or view the artworks record which can be included in the Platform NFT at the time of the sale. This means that artist can still view information about artwork that was available when he sold it, such as its description, image, provenance, authenticity analysis, etc., but this also allows the artist to keep track of his portfolio art for the purpose of maintaining records for his catalog raisonné, copyright, royalties and estate.

However, in this case, any special permission granted in the platform NFT does not give the artist unfettered access to further information that is added to artwork after sale. This means that the artist can only see any new data that he/she is contractually entitled to see that may have been generated after the original Platform NFT was issued, such as logs, history, stories, transactions, reports, exhibitions, etc. This ensures that the privacy and security of the current owner are respected and protected, while also protecting the rights of the artist.

### 4 Implementations and Embodiments of the Disclosed Technology

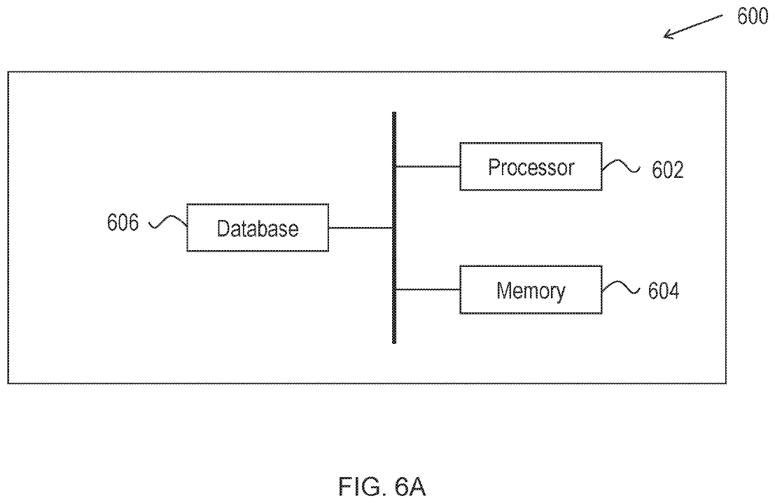

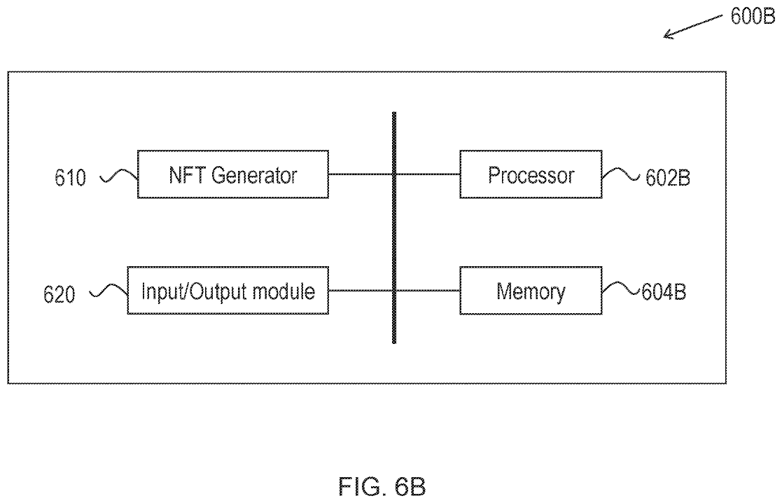

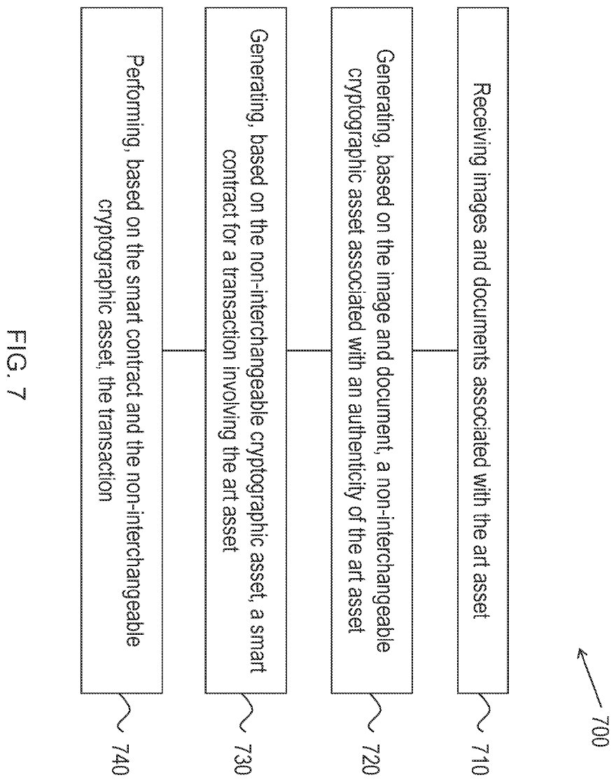

FIG. 6A shows an example of a hardware platform 600 that can be used to implement some of the techniques described in the present document. The hardware platform 600 may include a processor 602 that can execute code to implement a method described in this document (e.g., method 700 shown in FIG. 7) and a memory 604 that may be used to store processor-executable code and/or store data, and may further include a database 606, which stores blockchain and NFT information as described in this document.

FIG. 6B shows another example of a hardware platform 600B that can be used to implement some of the techniques described in the present document. The hardware platform 600B may include a processor 602B that can execute code to implement a method described in this document (e.g., method 700 shown in FIG. 7). The hardware platform 600B may include a memory 604B that may be used to store processor-executable code and/or store data. The hardware platform 600B may further include an NFT generator 610. For example, the NFT generator 610 may generate one or more of the copyright NFTs, title NFTs, platform NFTs, and the like. The hardware platform 600B may further include an input/output module 620, which is configured to implement the various interactions associated with a distributed ledger technology, as described in this document. In some embodiments, some portion or all of the NFT generator 610, may be implemented in the processor 602B. In other embodiments, the memory 604B may comprise multiple memories, some of which are exclusively used by the processor and/or the NFT generator. In various implementations, the hardware platform 600 can include the structural and/or functional features of the hardware platform 600B, and vice versa.

FIG. 7 shows an example of a method 700 for protecting an art asset. The method 700 includes, at operation 710, receiving images and documents associated with the art asset. In an example, the images and documents are received from a computing system associated with (or operated by) a seller, owner, or seller agent.

The method 700 includes, at operation 720, generating, based on the image and document, a non-interchangeable cryptographic asset (e.g., Platform NFT described in Section 2.1) associated with an authenticity of the art asset.

The method 700 includes, at operation 730, generating, based on the non-interchangeable cryptographic asset, a smart contract (e.g., AuthX smart contract described in Section 2.4) for a transaction involving the art asset.

The method 700 includes, at operation 740, performing, based on the smart contract and the non-interchangeable cryptographic asset, the transaction.

Embodiments of the disclosed technology also include a system for protecting an art asset, comprising a database resident on one or more computers, a processor in communication with the database, and a non-transitory memory including processor-executable code, wherein the processor-executable code upon execution by the processor causes the processor to authenticate data associated with an art asset and generate a set of cryptographic assets associated with the art asset. The processor receives at least one document and at least one image associated with the art asset, and generates, based on a digital representation of the at least one document and the at least one image, a platform cryptographic asset for the art asset. The platform cryptographic asset is used to generate a smart contract to perform at least one transaction involving the art asset, and the smart contract is executed to perform the at least one transaction. In this system, the set of cryptographic assets comprises (i) the platform cryptographic asset, (ii) a copyright cryptographic asset associated with a copyright of the art asset that includes royalty rights and reproduction rights, and (iii) a title cryptographic asset associated with ownership data of the art asset, and the set of cryptographic assets and the smart contract are stored on a distributed ledger.

Embodiments of the disclosed technology also include a method for protecting an art asset that includes receiving, from at least a computing system associated with a seller of the art asset, images and documents associated with the art asset. The method further includes digitizing the images and documents, and converting a first format of digitized images and documents to a second format to generate a digital representation of the images and documents, the first format being incompatible with one or more data structures being used by a platform cryptographic asset. The method includes generating, based on a digital representation of the images and documents, the platform cryptographic asset associated with an authenticity of the art asset, authenticating the platform cryptographic asset using a proof-of-work consensus mechanism or a proof-of-stake consensus mechanism, and generating, based on the authenticating being successful, a title cryptographic asset associated an ownership of the art asset and a copyright cryptographic asset associated with a copyright of the art asset that includes royalty rights and reproduction rights. Having generated the cryptographic assets, the method includes generating, based on the platform cryptographic asset and the title cryptographic asset, a smart contract for a transaction involving the art asset between the seller and a buyer, verifying a transfer of funds from a buyer to a seller, and transferring the title cryptographic asset to a digital wallet associated with the buyer.

The described embodiments provide, inter alia, the following technical solutions.

Solution 1 includes a system for protecting an art asset includes a database resident on one or more computers; at least one processor in communication with the database; and a non-transitory memory including processor-executable code, wherein the processor-executable code upon execution by the at least one processor causes the at least one processor to authenticate data associated with an art asset and generate a set of cryptographic assets associated with the art asset, by: receiving one or more images representative of the art asset, generating, based on the one or more images, an identifier for the art asset, and generate a plurality of cryptographic assets associated with the art asset, wherein the plurality of cryptographic assets comprises (i) a copyright cryptographic asset associated with a copyright of the art asset that includes royalty rights and reproduction rights, (ii) a title cryptographic asset associated with ownership data of the art asset, and (iii) a platform cryptographic asset associated with one or more transactions involving the art asset.

Solution 2 includes the system of any of solutions 1 to 9, wherein the system is architected as a plurality of platforms comprising an artist platform to receive the one or more images representative of the art asset from the artist platform; and an authentication platform, communicatively coupled to the artist platform, to: generate, based on the one or more images, the identifier for the art asset, and generate the plurality of cryptographic assets associated with the art asset.

Solution 3 includes the system of solution 2 or any of solutions 1 to 9, wherein the copyright cryptographic asset and the title cryptographic asset are transferable assets, and wherein the platform cryptographic asset is a non-transferable asset.

Solution 4 includes the system of solution 2 or any of solutions 1 to 9, wherein the authentication platform is further configured, in response to the art asset being a physical art asset, to generate a log entry for a generation of an identification tag, an attachment of the identification tag to the physical art asset, and prior to generating the plurality of cryptographic assets, an activation of the identification tag.

Solution 5 includes the system of solution 4 or any of solutions 1 to 9, wherein the identification tag comprises a near-field communication (NFC) tag or an ultra-high frequency (UHF) tag.

Solution 6 includes the system of solution 2 or any of solutions 1 to 9, wherein the plurality of platforms further comprises: a transaction platform configured to receive, from an owner of the title cryptographic asset, an indication of the art asset being for sale, wherein the authentication platform is further configured to: verify a transfer of funds from a buyer to the seller, transfer the title cryptographic asset to a wallet associated with the buyer, transfer the identifier for the art asset to the buyer, and rescind a validity of the platform cryptographic asset.

Solution 7 includes the system of solution 2 or any of solutions 1 to 9, wherein the plurality of platforms further comprises: a transaction platform configured to receive, from an owner of the title cryptographic asset, an indication of a creation of a derivative work based on the art asset, wherein the authentication platform is further configured to: validate the copyright cryptographic asset, and in response to the copyright cryptographic asset being valid, create a new title cryptographic asset associated with ownership data of the derivative work and a new platform cryptographic asset associated with one or more transactions involving the derivative work.

Solution 8 includes the system of solution 7 or any of solutions 1 to 9, wherein the art asset is a physical art asset, and wherein the derivative work comprises a print, a lithograph, or a limited edition.

Solution 9 includes the system of solution 2 or any of solutions 1 to 9, wherein each cryptographic asset of the plurality of cryptographic assets is a non-fungible token (NFT) stored on a blockchain.

Solution 10 includes a method of authenticating and managing art data and art assets, the method being implemented using the system of any of solutions 1 to 9.

Solution 11 includes a method of protecting an art asset, implemented on a processor, the method comprising: receiving, from at least a computing system associated with a seller of the art asset, images and documents associated with the art asset; digitizing the images and documents; converting a first format of digitized images and documents to a second format to generate a digital representation of the images and documents; generating, based on a digital representation of the images and documents, the platform cryptographic asset associated with an authenticity of the art asset; authenticating the platform cryptographic asset using a proof-of-work consensus mechanism or a proof-of-stake consensus mechanism; generating, based on the authenticating being successful, a title cryptographic asset associated an ownership of the art asset and a copyright cryptographic asset associated with a copyright of the art asset that includes royalty rights and reproduction rights; generating, based on the platform cryptographic asset and the title cryptographic asset, a smart contract for a transaction involving the art asset between the seller and a buyer; verifying a transfer of funds from a buyer to a seller; and transferring the title cryptographic asset to a digital wallet associated with the buyer. In some embodiments of the method of solution 11 or any of solutions 11 to 19, the first format is incompatible with one or more data structures being used by a platform cryptographic asset.

Solution 12 includes the method of solution 11 or any of solutions 11 to 19, the method further comprising: rescinding, subsequent to transferring the title cryptographic asset, a validity of the platform cryptographic asset.

Solution 13 includes the method of solution 11 or any of solutions 11 to 19, the method further comprising: selecting, based on computational resources associated with the processor, the proof-of-work consensus mechanism or the proof-of-stake consensus mechanism.

Solution 14 includes the method of solution 11 or any of solutions 11 to 19, the method further comprising: receiving, from an owner of the title cryptographic asset, an indication of a creation of a derivative work based on the art asset; validate the copyright cryptographic asset, and in response to the copyright cryptographic asset being valid, create a new title cryptographic asset associated with ownership data of the derivative work and a new smart contract associated with one or more transactions involving the derivative work.

Solution 15 includes the method of solution 11 or any of solutions 11 to 19, wherein the copyright cryptographic asset and the title cryptographic asset are transferable assets, and wherein the platform cryptographic asset is a non-transferable asset.

Solution 16 includes the method of solution 11 or any of solutions 11 to 19, the method further comprising: generating, in response to the art asset being a physical art asset, an identification tag.

Solution 17 includes the method of solution 16 or any of solutions 11 to 19, wherein the identification tag is attached to the physical art asset, and wherein the identification tag is activated prior to the generation of cryptographic assets associated with the art asset, thereby ensuring the physical art asset can be tracked if the generation of one at least one cryptographic asset is delayed.

Solution 18 includes the method of solution 16 or 17 or any of solutions 11 to 19, wherein the identification tag comprises a radio frequency identification (RFID) near-field communication (NFC) tag, or an RFID ultra-high frequency (UHF) tag.

Solution 19 includes the method of solution 18 or any of solutions 11 to 19, wherein the platform cryptographic asset comprises one or more of (i) a gallery cryptographic asset that is configured to display the at least one image in a digital wallet, (ii) a mandate cryptographic asset that is issued by an owner of the art asset to a dealer or seller agent for consignment purposes, or (iii) a due diligence cryptographic asset configured to provide an initial authentication or validation of the at least one document or the at least one image.

Solution 20 includes a system for protecting an art asset, comprising: a database resident on one or more computers; at least one processor in communication with the database; and a non-transitory memory including processor-executable code, wherein the processor-executable code upon execution by the at least one processor causes the at least one processor to authenticate data associated with the art asset and generate a set of cryptographic assets associated with the art asset, by: receiving at least one document and at least one image associated with the art asset, generating, based on a digital representation of the at least one document and the at least one image, a platform cryptographic asset for the art asset, generating, based on the platform cryptographic asset, a smart contract to perform at least one transaction involving the art asset, and executing the smart contract to perform the at least one transaction, wherein the set of cryptographic assets comprises (i) the platform cryptographic asset, (ii) a copyright cryptographic asset associated with a copyright of the art asset that includes royalty rights and reproduction rights, and (iii) a title cryptographic asset associated with ownership data of the art asset, and wherein the set of cryptographic assets and the smart contract are stored on a distributed ledger.

Solution 21 includes the system of solution 20 or any of the solutions 20 to 32, wherein the platform cryptographic asset comprises one or more of (i) a gallery cryptographic asset that is configured to display the at least one image in a digital wallet, (ii) a mandate cryptographic asset that is issued by an owner of the art asset to a dealer or seller agent for consignment purposes, or (iii) a due diligence cryptographic asset configured to provide an initial authentication or validation of the at least one document or the at least one image.

Solution 22 includes the system of solution 20 or any of the solutions 20 to 32, wherein the processor-executable code upon execution by the at least one processor further causes the at least one processor to: generate, in response to the art asset being a physical art asset, an identification tag.

Solution 23 includes the system of solution 22 or any of the solutions 20 to 32, wherein the identification tag is attached to the physical art asset, and wherein the identification tag is activated prior to the generation of the set of cryptographic assets, thereby ensuring the physical art asset can be tracked if the generation of one of the set of cryptographic assets is delayed.

Solution 24 includes the system of solution 22 or any of the solutions 20 to 32, wherein the identification tag comprises a radio frequency identification (RFID) near-field communication (NFC) tag, or an RFID ultra-high frequency (UHF) tag.

Solution 25 includes the system of solution 20 or any of the solutions 20 to 32, wherein the copyright cryptographic asset and the title cryptographic asset are transferable assets, and wherein the platform cryptographic asset is a non-transferable asset.

Solution 26 includes the system of any of solutions 20 to 25 or any of the solutions 20 to 32, wherein the smart contract is configured to: verify a transfer of funds from a buyer to a seller, transfer the title cryptographic asset to a wallet associated with the buyer, and rescind a validity of the platform cryptographic asset.

Solution 27 includes the system of any of solutions 20 to 25 or any of the solutions 20 to 32, wherein the processor-executable code upon execution by the at least one processor further causes the at least one processor to: receive, from an owner of the title cryptographic asset, an indication of a creation of a derivative work based on the art asset; validate the copyright cryptographic asset, and in response to the copyright cryptographic asset being valid, create a new title cryptographic asset associated with ownership data of the derivative work and a new smart contract associated with one or more transactions involving the derivative work.

Solution 28 includes the system of solution 27 or any of the solutions 20 to 32, wherein validating the copyright cryptographic asset is based on either a proof-of-work consensus mechanism or a proof-of-stake consensus mechanism.

Solution 29 includes the system of solution 28 or any of the solutions 20 to 32, wherein either the proof-of-work consensus mechanism or the proof-of-stake consensus mechanism is selected based on an availability of computational resources associated with the at least one processor.

Solution 30 includes the system of solution 27 or any of the solutions 20 to 32, wherein the art asset is a physical art asset, and wherein the derivative work comprises a print, a lithograph, or a limited edition.

Solution 31 includes the system of any of solutions 20 to 25 or any of the solutions 20 to 32, wherein the processor-executable code upon execution by the at least one processor further causes the at least one processor, as part of generating the platform cryptographic asset, to: digitize the at least one document; convert a first format of the at least one document to a second format to generate the digital representation of the at least one document, wherein the first format is incompatible with one or more data structures being used by the platform cryptographic asset.

Solution 32 includes the system of any of solution 20 to 22 or any of the solutions 20 to 32, wherein each cryptographic asset of the set of cryptographic assets is a non-fungible token (NFT), and wherein the distributed ledger is a blockchain.

Solution 33 includes a method of authenticating and managing art data and art assets, the method being implemented using the system of one or more of solution 20 to 32.

Solution 34 includes a method of protecting an art asset, implemented on a processor, the method comprising: receiving at least one document and at least one image associated with the art asset; generating, based on a digital representation of the at least one document and the at least one image, a platform cryptographic asset for the art asset; generating, based on the platform cryptographic asset, a smart contract to perform at least one transaction involving the art asset; and executing the smart contract to perform the at least one transaction, wherein the set of cryptographic assets comprises (i) the platform cryptographic asset, (ii) a copyright cryptographic asset associated with a copyright of the art asset that includes royalty rights and reproduction rights, and (iii) a title cryptographic asset associated with ownership data of the art asset, and wherein the set of cryptographic assets and the smart contract are stored on a distributed ledger.

Solution 35 includes the method of solution 35, wherein the method being implemented using the system of one or more of solution 20 to 32.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that arc described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method of protecting an art asset, implemented on a processor, the method comprising:
receiving, from at least a computing system associated with a seller of the art asset, images and documents associated with the art asset;
digitizing the images and documents;
converting a first format of digitized images and documents to a second format to generate a digital representation of the images and documents, wherein the first format is incompatible with one or more data structures being used by a platform cryptographic asset;
generating, based on a digital representation of the images and documents, the platform cryptographic asset associated with an authenticity of the art asset;
authenticating the platform cryptographic asset using a proof-of-work consensus mechanism or a proof-of-stake consensus mechanism;
generating, based on the authenticating being successful, a title cryptographic asset associated an ownership of the art asset and a copyright cryptographic asset associated with a copyright of the art asset that includes royalty rights and reproduction rights;
generating, based on the platform cryptographic asset and the title cryptographic asset, a smart contract for a transaction involving the art asset between the seller and a buyer;
verifying a transfer of funds from a buyer to a seller; and
transferring the title cryptographic asset to a digital wallet associated with the buyer.

2. The method of claim 1, further comprising:
rescinding, subsequent to transferring the title cryptographic asset, a validity of the platform cryptographic asset.

3. The method of claim 1, further comprising:
selecting, based on computational resources associated with the processor, the proof-of-work consensus mechanism or the proof-of-stake consensus mechanism.

4. The method of claim 1, further comprising:
receiving, from an owner of the title cryptographic asset, an indication of a creation of a derivative work based on the art asset;
validate the copyright cryptographic asset, and
in response to the copyright cryptographic asset being valid, create a new title cryptographic asset associated with ownership data of the derivative work and a new smart contract associated with one or more transactions involving the derivative work.

5. The method of claim 1, wherein the copyright cryptographic asset and the title cryptographic asset are transferable assets, and wherein the platform cryptographic asset is a non-transferable asset.

6. The method of claim 1, further comprising:
generating, in response to the art asset being a physical art asset, an identification tag.

7. The method of claim 6, wherein the identification tag is attached to the physical art asset, and wherein the identification tag is activated prior to the generation of cryptographic assets associated with the art asset, thereby ensuring the physical art asset can be tracked if the generation of one at least one cryptographic asset is delayed.

8. The method of claim 7, wherein the identification tag comprises a radio frequency identification (RFID) near-field communication (NFC) tag, or an RFID ultra-high frequency (UHF) tag.

9. The method of claim 8, wherein the platform cryptographic asset comprises one or more of (i) a gallery cryptographic asset that is configured to display the at least one image in a digital wallet, (ii) a mandate cryptographic asset that is issued by an owner of the art asset to a dealer or seller agent for consignment purposes, or (iii) a due diligence cryptographic asset configured to provide an initial authentication or validation of the at least one document or the at least one image.

10. A system for protecting an art asset, comprising:
a database resident on one or more computers;
at least one processor in communication with the database; and
a non-transitory memory including processor-executable code, wherein the processor-executable code upon execution by the at least one processor causes the at least one processor to authenticate data associated with the art asset and generate a set of cryptographic assets associated with the art asset, by:
receiving at least one document and at least one image associated with the art asset,
generating, based on a digital representation of the at least one document and the at least one image, a platform cryptographic asset for the art asset,
generating, based on the platform cryptographic asset, a smart contract to perform at least one transaction involving the art asset, and
executing the smart contract to perform the at least one transaction,
wherein the set of cryptographic assets comprises (i) the platform cryptographic asset, (ii) a copyright cryptographic asset associated with a copyright of the art asset that includes royalty rights and reproduction rights, and (iii) a title cryptographic asset associated with ownership data of the art asset, and
wherein the set of cryptographic assets and the smart contract are stored on a distributed ledger.

11. The system of claim 10, wherein the platform cryptographic asset comprises one or more of (i) a gallery cryptographic asset that is configured to display the at least one image in a digital wallet, (ii) a mandate cryptographic asset that is issued by an owner of the art asset to a dealer or seller agent for consignment purposes, or (iii) a due diligence cryptographic asset configured to provide an initial authentication or validation of the at least one document or the at least one image.

12. The system of claim 10, wherein the processor-executable code upon execution by the at least one processor further causes the at least one processor to:
generate, in response to the art asset being a physical art asset, an identification tag.

13. The system of claim 12, wherein the identification tag is attached to the physical art asset, and wherein the identification tag is activated prior to the generation of the set of cryptographic assets, thereby ensuring the physical art asset can be tracked if the generation of one of the set of cryptographic assets is delayed.

14. The system of claim 12, wherein the identification tag comprises a radio frequency identification (RFID) near-field communication (NFC) tag, or an RFID ultra-high frequency (UHF) tag.

15. The system of claim 10, wherein the copyright cryptographic asset and the title cryptographic asset are transferable assets, and wherein the platform cryptographic asset is a non-transferable asset.

16. The system of claim 10, wherein the smart contract is configured to:
verify a transfer of funds from a buyer to a seller,
transfer the title cryptographic asset to a wallet associated with the buyer, and
rescind a validity of the platform cryptographic asset.

17. The system of claim 10, wherein the processor-executable code upon execution by the at least one processor further causes the at least one processor to:
receive, from an owner of the title cryptographic asset, an indication of a creation of a derivative work based on the art asset;
validate the copyright cryptographic asset, and
in response to the copyright cryptographic asset being valid, create a new title cryptographic asset associated with ownership data of the derivative work and a new smart contract associated with one or more transactions involving the derivative work.

18. The system of claim 17, wherein validating the copyright cryptographic asset is based on either a proof-of-work consensus mechanism or a proof-of-stake consensus mechanism.

19. The system of claim 18, wherein either the proof-of-work consensus mechanism or the proof-of-stake consensus mechanism is selected based on an availability of computational resources associated with the at least one processor.

20. The system of claim 17, wherein the art asset is a physical art asset, and wherein the derivative work comprises a print, a lithograph, or a limited edition.

21. The system of claim 10, wherein the processor-executable code upon execution by the at least one processor further causes the at least one processor, as part of generating the platform cryptographic asset, to:
digitize the at least one document;
convert a first format of the at least one document to a second format to generate the digital representation of the at least one document,
wherein the first format is incompatible with one or more data structures being used by the platform cryptographic asset.

22. The system of claim 10, wherein each cryptographic asset of the set of cryptographic assets is a non-fungible token (NFT), and wherein the distributed ledger is a blockchain.

23. (canceled)
